(19) United States
(12) Patent Application Publication
(10) Pub. No.: US 2024/0157308 A1
(43) Pub. Date: May 16, 2024

(54) MICROPOROUS GRAPHENE OXIDE SHEET, DISPERSION, AND MEMBRANE INCLUDING THE SAME

(71) Applicant: KOREA ADVANCED INSTITUTE OF SCIENCE AND TECHNOLOGY, Daejeon (KR)

(72) Inventors: MinKee Choi, Daejeon (KR); Chaehoon Kim, Daejeon (KR)

(21) Appl. No.: 18/509,312

(22) Filed: Nov. 15, 2023

(30) Foreign Application Priority Data
Nov. 15, 2022 (KR) 10-2022-0152964

(51) Int. Cl. B01D 71/02; B01D 67/00; C01B 32/186; C01B 32/198

(52) U.S. Cl. CPC B01D 71/0211; B01D 67/0088; C01B 32/186; C01B 32/198; B01D 2323/21819; B01D 2325/04; C01P 2006/16

(57) ABSTRACT

Disclosed are a microporous graphene oxide sheet, a method of manufacturing the same, a dispersion including the same, and a membrane including a stack of the microporous graphene oxide sheet, the microporous graphene oxide sheet having an average size of pores ranging from about 0.1 nm to about 2 nm, wherein a spacing between pores is about 0.3 nm to about 10 nm, a standard deviation for the spacing between pores is less than or equal to about 5 nm.

### CROSS-REFERENCE TO RELATED APPLICATION

This application claims priority to and the benefit of Korean Patent Application No. 10-2022-0152964 filed in the Korean Intellectual Property Office on Nov. 15, 2022, the entire contents of which are incorporated herein by reference.

### BACKGROUND OF THE INVENTION

### (a) Field of the Invention

A microporous graphene oxide sheet, and a dispersion and a membrane including the same are disclosed.

### (b) Description of the Related Art

A graphene-based two-dimensional carbon material is attracting attentions in various fields such as separation membrane, electrochemical energy storage, transistor, and the like due to unique physical and chemical stability. However, since graphene is made up of a tightly arranged sp² hybrid carbon skeleton and thus impermeable to all molecules and ions, in order to use the graphene as a separation membrane material, a structural design of providing the graphene with permeability to a target material such as forming a pore or a passage is essential.

A conventional method of manufacturing microporous graphene with several nano-sized pores is largely classified into a top-down method and a bottom-up method. The top-down method may include a method of forming defects in graphene by using ion bombardment, UV, plasma, and the like, but this method has difficulties in mass production due to non-uniform sized pores and low pore density of about 1 pore/100 nm². In addition, there is another oxidative etching method of treating graphene with hydrogen peroxide and the like, which may form lots of pores but has limitations of irregularly forming non-uniform sized pores and lowering conductivity due to lots of defects. The bottom-up method is to synthesize a precursor first and polymerize it into microporous graphene, which may not only be complicated and uneconomical from the precursor synthesis itself to the graphene production, but also may not be used as a large area membrane due to too high defect density.

Non-patent Document 1, etc. propose a method of manufacturing microporous carbon with a three-dimensional structure by depositing carbon on a three-dimensional zeolite skeleton and then, selectively removing the zeolite.

Subsequent studies on carbon materials using a three-dimensional zeolite template have been presented, which are to synthesize carbon materials with a three-dimensional structure such as a ribbon shape, a tube shape, and the like. However, these carbon materials have limitations in being manufactured into a membrane due to a high aspect ratio and the three-dimensional shapes.

In addition, a microporous carbon material with a two-dimensional structure may be manufactured but manufactured into a semi-permanently stacked form due to strong π-π attraction between carbon sheets with an aromatic skeleton. In order to manufacture this microporous carbon material with a two-dimensional structure into a defect-free membrane, a process of exfoliating carbon sheets into single sheets having a monoatomic thickness and dispersing them in a solution must proceed ahead. However, since the sheets have so strong attraction as to be not only exfoliated but also not dispersed in a solution, it is essential to introduce technology to weaken the attraction between the carbon sheets.
[Non-patent Document 1] T. Kyotani et al., Chem. Mater. 13, 4413 (2001)

### SUMMARY OF THE INVENTION

An embodiment of the present invention provides a microporous graphene oxide sheet in which nanopores with a uniform size are regularly present and which have a monoatomic thickness, a method of manufacturing the same, and a dispersion in which the sheets are dispersed. In addition, provided are a membrane including a stack that the microporous graphene oxide sheets are layer by layer interlocked and stacked and a method of manufacturing the same.

In an embodiment, a microporous graphene oxide sheet has an average size of pores ranging from about 0.1 nm to about 2 nm, wherein a spacing between pores is about 0.3 nm to about 10 nm, a standard deviation for the spacing between pores is less than or equal to about 5 nm, and the microporous graphene oxide sheet has a thickness of less than or equal to about 2 nm.

In an embodiment, a method of manufacturing a microporous graphene oxide sheet includes depositing carbon on a zeolite template having a two- dimensional pore structure to prepare a carbon-zeolite composite, oxidizing the carbon-zeolite composite, removing the zeolite from the oxidized carbon-zeolite composite to obtain microporous graphene oxide, and treating the obtained product with sonication in a solvent to obtain a microporous graphene oxide sheet having a thickness of less than or equal to about 2 nm.

In an embodiment, a dispersion includes a solvent, and a microporous graphene oxide sheets dispersed in the solvent and having a thickness of less than or equal to about 2 nm.

In an embodiment, a membrane including a stack of the microporous graphene oxide sheets is provided.

In an embodiment, a method of manufacturing a membrane includes manufacturing microporous graphene oxide sheets using the above-described method and then stacking them on a substrate.

The microporous graphene oxide sheet according to an embodiment is a microporous carbon material with uniform pore size, regular spacing between pores, and high pore density, and a graphene oxide sheet that is exfoliated to a monoatomic thickness of less than or equal to about 2 nm and can exist in a dispersed state in a solution. These microporous graphene oxide sheets are stacked layer by layer, interlocking with each other, making it possible to manufacture a membrane without defects or pinholes. In addition, the microporous graphene oxide sheet and the dispersion and membrane including the same can be manufactured through a solution process, making it advantageous and economical for mass production. The membrane has excellent performance in selectively permeating target materials and can be used as various separators or filters. In addition, the microporous graphene oxide sheet can be used in various fields such as energy storage materials such as electrode active materials, electronic materials such as quantum dots, chemical detectors, or various catalysts.

### BRIEF DESCRIPTION OF THE DRAWINGS

FIG. 1 is a schematic view showing the shapes of manufacturing membranes by stacking a non-exfoliated carbon material (left) and an exfoliated carbon material (right) having a monoatomic thickness.

FIG. 2 is a schematic view showing a method of manufacturing a microporous graphene oxide sheet and subsequently a method of manufacturing a membrane according to an embodiment.

FIG. 3 shows images taken of the microporous graphene prepared in Reference Example 1 using an atomic force microscope (AFM) (top) and a graph analyzing the thickness (bottom).

FIG. 4 is a transmission electron microscope (TEM) image of the surface of the microporous graphene oxide sheet manufactured in Example 1.

FIG. 5 is an atomic force microscope image (left) of the microporous graphene oxide sheet manufactured in Example 1, and a graph analyzing the thickness at positions 1 and 2 (right).

FIG. 6 is a photograph of the membrane manufactured in Example 1.

FIG. 7 is a scanning electron microscope (SEM) image of the surface of the carbon-coated portion of the membrane manufactured in Example 1.

FIG. 8 is a scanning electron microscope image of a cross section of the membrane manufactured in Example 1.

FIG. 9 is a graph evaluating the organic solvent nanofiltration characteristics of the membrane manufactured in Example 1, showing the permeability of methanol and the filtration rate (rejection rate) according to the molecular weight of organic dye molecules.

FIG. 10 is a graph comparing the performance of the membrane manufactured in Example 1 with previously reported organic solvent nanofiltration membranes and showing the filtration rate of organic dye molecules and methanol permeability.

### DETAILED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

As used herein, “combination thereof” means mixture, laminates, composites, copolymers, alloys, blends, reaction products, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawing, the thickness is shown enlarged to clearly express the various layers and regions. It will be understood that when an element such as a layer, film, region, or substrate is referred to as being “on” another element, it can be directly on the other element or intervening elements may also be present. In contrast, when an element is referred to as being “directly on” another element, there are no intervening elements present. “Layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

### Microporous Graphene Oxide Sheet

In an embodiment, a microporous graphene oxide sheet has an average size of pores ranging from about 0.1 nm to about 2 nm, wherein a spacing between pores is about 0.3 nm to about 10 nm, a standard deviation for the spacing between pores is less than or equal to about 5 nm, and the microporous graphene oxide sheet has a thickness of less than or equal to about 2 nm.

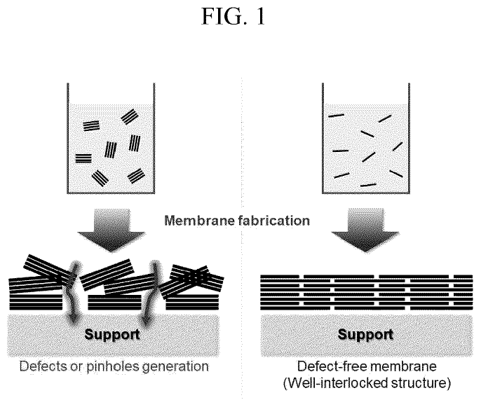

The graphene oxide sheet may be said to be an exfoliated graphene oxide sheet having a monoatomic thickness. As shown at the left of FIG. 1, even though a two-dimensional microporous carbon material is successfully manufactured, if not exfoliated into monoatomic thick sheets, it is difficult to interlock layer by layer and stack into a membrane and more difficult into a high-quality membrane due to defects or pinholes in the structure. On the contrary, as shown at the right of FIG. 1, the monoatomic thick exfoliated graphene oxide sheets according to an embodiment may from a membrane with a well-interlocked structure in which the sheets are interlocked each other as a layer-by-layer assembly. Such a membrane has neither defects nor pinholes in the structure and thus may exhibit excellent separation performance for a target material and high physical and chemical stability.

The microporous graphene oxide sheet according to an embodiment may have a thickness of less than or equal to about 2 nm, for example less than or equal to about 1.5 nm, less than or equal to about 1 nm, or less than or equal to about 1 nm, for example about 0.1 nm to about 2 nm, about 0.1 nm to about 1.5 nm, about 0.3 nm to about 1 nm, or about 0.34 nm to about 2 nm. A sheet with this thickness can be interpreted as a sheet with a monoatomic layer, or less than 5 layers, or less than 3 layers.

Lateral dimensions, that is, the horizontal and vertical lengths, of the microporous graphene oxide sheet may be approximately about 50 nm to about 1,000 nm. Additionally, an area of the microporous graphene oxide sheet may be about 2,500 nm² to about 1,000,000 nm².

The microporous graphene oxide sheet may have an atomic ratio of oxygen to carbon of about 0.1 to about 1.0, for example, about 0.2 to about 0.9, about 0.3 to about 0.8, or about 0.4 to about 0.7. The graphene oxide sheet may be referred to as partially oxidized or fully oxidized graphene. In addition, the microporous graphene oxide sheet may include about 10 wt% to about 60 wt % of oxygen, for example about 25 wt % to about 55 wt %, or about 30 wt % to about 50 wt % based on 100 wt % of the microporous graphene oxide sheet. These graphene oxide sheets can be dispersed in solution, making them easy to apply in manufacturing and application processes.

In addition, the microporous graphene oxide sheet according to an embodiment has a uniform pore size, regular spacing between pores, and high pore density. Graphene-based carbon materials having a non-uniform pore size, an irregular pore distribution, or low pore density has been conventionally reported but are impossible to manufacture into a high-quality membrane and in general, are uneconomical and have difficulties in mass production. On the contrary, the microporous graphene oxide sheets according to an embodiment, in which nanopores with a uniform size are regularly present with high density, may be used for a high-quality membrane, and in addition, since a solution process is applied thereto, its manufacturing method is simple and economical and has an advantage of mass production.

Herein, the ‘microporous’ means having pores of less than or equal to about 2 nm. In other words, micro-pores may mean pores with a size of less than or equal to about 2 nm.

The microporous graphene oxide sheet according to an embodiment may be said to be a graphene oxide sheet in which pores of about 0.1 nm to about 2 nm in size exist. The average size of the pores may be for example about 0.1 nm to about 1.9 nm, about 0.1 nm to about 1.8 nm, about 0.1 nm to about 1.7 nm, about 0.1 nm to about 1.6 nm, about 0.1 nm to about 1.5 nm, about 0.1 nm to about 1.4 nm, about 0.1 nm to about 1.3 nm, about 0.1 nm to about 1.2 nm, about 0.1 nm to about 1.1 nm, about 0.2 nm to about 1.0 nm, about 0.3 nm to about 0.9nm, or about 0.4 nm to about 0.8 nm. If the average pore size satisfies this range, the microporous graphene oxide sheet is advantageous in selectively permeating molecules or ions and can be used in various fields.

The pore is a two-dimensional pore and may have a circular, oval, or polygonal shape, for example, a shape substantially close to a circular shape.

The size of the pore may mean a diameter if the pore is circular, and if the pore is not circular, it may mean the longest length among the lengths corresponding to the diameter or the length of the longest axis. Additionally, the size of the pores may be measured through photographs taken with an electron microscope such as a scanning electron microscope or a transmission electron microscope.

The average size may be an arithmetic average of sizes measured using electron micrographs. For example, the average size of pores can be derived by measuring the sizes of about 50 pores in an electron micrograph and calculating their arithmetic average.

The microporous graphene oxide sheet according to an embodiment has very uniform pore sizes. For example, the standard deviation for the average size of the pores may be less than or equal to about 1 nm, for example less than or equal to about 0.9 nm, less than or equal to about 0.8 nm, less than or equal to about 0.7 nm, less than or equal to about 0.6 nm, less than or equal to about 0.5 nm, less than or equal to about 0.4 nm, less than or equal to about 0.3 nm, less than or equal to about 0.2 nm, less than or equal to about 0.1 nm, less than or equal to about 0.09 nm, or less than or equal to about 0.08 nm, and greater than or equal to about 0.001 nm, or greater than or equal to about 0.01 nm. In this way, when the standard deviation of the average pore size is small, that is, when the pore size is very uniform, the performance of selectively permeating molecules or ions is excellent, and thus it is advantageous for application to various membranes or electrode materials.

In the microporous graphene oxide sheet according to an embodiment, the spacing between pores is not too narrow or too far but is within an appropriate range, and the spacing is very regular. Specifically, the average spacing between pores may be about 0.3 nm to about 10 nm, and the standard deviation thereof may be less than or equal to about 5 nm. Herein, the spacing between pores may mean the distance from the center of the pore to the center of the adjacent pore. The average spacing between pores may be the arithmetic average of the spacing measured using electron micrographs, etc. For example, the average spacing between pores can be derived by measuring the spacing between 50 random pores in an electron microscope photograph and calculating their arithmetic mean value and standard deviation. Alternatively, the spacing between pores may be measured through X-ray diffraction (XRD).

The spacing between the pores may be, for example, about 0.3 nm to about 10 nm, about 0.3 nm to about 9 nm, about 0.3 nm to about 8 nm, about 0.3 nm to about 7 nm, about 0.3 nm to about 6 nm, about 0.4 nm to about 5 nm, about 0.5 nm to about 4 nm, about 0.6 nm to about 3 nm, about 0.8 nm to about 2 nm, or about 1.0 nm to about 1.5 nm. The microporous graphene oxide sheet in which the spacing between pores satisfies this range has an appropriate pore density, is effective in selectively permeating various molecules or ions, and is therefore advantageous for application in various fields.

The standard deviation for the spacing between the pores may be, for example, less than or equal to about 5 nm, less than or equal to about 4 nm, less than or equal to about 3 nm, less than or equal to about 2 nm, less than or equal to about 1 nm, less than or equal to about 0.5 nm, less than or equal to about 0.1 nm, or less than or equal to about 0.08 nm, and greater than or equal to about 0.001 nm or greater than or equal to about 0.01 nm. In this way, when the spacing between the pores has a small standard deviation, the spacing between the pores may be very regular, and the graphene oxide sheets with this spacing are effective in selectively permeating molecules or ions and thus may be used in various fields such as a separation membrane, an electrode material, or the like.

The microporous graphene oxide sheets may exhibit high pore density, for example, about 10 pores/100 nm² to about 100 pores/100 nm², for example, about 20 pores/about 100 nm² to about 100 pores/100 nm², about 30 pores/100 nm² to about 100 pores/100 nm², about 40 pores/100 nm² to about 90 pores/100 nm², or about 50 pores/100 nm² to about 80 pores/100 nm². When the pore density satisfies these ranges, the graphene oxide sheets effectively permeate molecules or ions selectively and may be suitably applied to various separation membranes, electrode materials, and the like.

The microporous graphene oxide sheets may exhibit a peak around 2θ of about 7.2° and/or about 7.6° in an X-ray spectroscopic analysis (XRD). Where 2θ is about 7.2° and about 7.6°, spacing between layers (d-spacing) may be respectively about 1.23 nm and about 1.16 nm. Such peaks prove that nanopores with a uniform size are regularly formed in the graphene oxide sheets.

The microporous graphene oxide sheets have lots of edge sites, through which various functional groups may be introduced thereinto. According to types and amounts of the functional groups, an effective pore size and surface polarity may be adjusted.

The microporous graphene oxide sheets according to an embodiment may be doped with sulfur, nitrogen, or a combination thereof. Herein, a doping amount may be about 0.1 wt % to about 20 wt %, for example, about 1 wt % to about 10 wt % based on 100 wt % of the microporous graphene. In other words, the microporous graphene oxide sheets may include about 0.1 wt % to about 20 wt % of nitrogen and about 0.1 wt % to about 20 wt % of sulfur. The microporous graphene oxide sheets, which are doped with sulfur, nitrogen, or a combination thereof, may have smaller effective pores but larger surface polarity. On the contrary, the edge sites of the microporous graphene oxide sheets may be substituted with hydrogen, wherein the effective pores become larger, but the surface polarity becomes lower. Accordingly, the pore size and the surface polarity, etc. may be variously adjusted according to desired characteristics in application fields.

### Method of Manufacturing Microporous Graphene Oxide Sheet

In an embodiment, a method of manufacturing a microporous graphene oxide sheet includes depositing carbon on a zeolite template having a two-dimensional pore structure to prepare a carbon-zeolite composite, oxidizing the carbon-zeolite composite, removing the zeolite from the oxidized carbon-zeolite composite to obtain microporous graphene oxide, and sonicating the product in a solvent to obtain a microporous graphene oxide sheet having a thickness of less than or equal to about 2 nm. According to the manufacturing method, a graphene oxide having a uniform pore size, regular spacing between pores, and high pore density may be prepared, which may be manufactured into a microporous graphene oxide sheet with a monoatomic layer thickness. In addition, the manufacturing method may be a solution process, which is simple and economical and makes mass production possible.

In the manufacturing method, after obtaining the carbon-zeolite composite by using the zeolite template with a two-dimensional pore structure, the zeolite template may be removed therefrom to obtain a two-dimensional graphene material with uniform nanopores. However, this obtained two-dimensional graphene has a thickness of several nanometers to tens of nanometers and a structure that about 10 or more monoatomic layers are stacked. Since strong π-π attraction acts between the carbon sheets with an aromatic skeleton, the sheets are in a semi-permanently stacked form.

However, this two-dimensional stacked structure, when manufactured into a membrane, as described above, generates defects or pinholes. Accordingly, in order to manufacture it into a membrane and the like, the microporous two-dimensional graphene stack must be exfoliated into sheets having a monoatomic thickness. Herein, whether the membrane is successfully manufactured or not may be determined by whether exfoliated or not. However, the attraction between the stacked sheets is so strong that the stacked sheets may not be exfoliated in a general method of treating microporous graphene with sonication after dispersing it in a solvent. When stronger energy than the π-π attraction, for example, horn-type ultrasonication may be provided, the energy is so strong that the graphene sheets may be broken while exfoliated.

In an embodiment, after manufacture the zeolite-carbon composite, before removing the zeolite template, an oxidation treatment is performed to obtain a partially oxidized graphene stack, the partially oxidized graphene stack is sonicated in a solution, succeeding in exfoliating it into microporous graphene oxide sheets having a monoatomic thickness. When the zeolite-carbon composite is oxidized, since oxygen functional groups such as O, OH, COOH, and the like are formed in the carbon layer, the sonication alone may exfoliate the carbon layer into graphene oxide sheets having a monoatomic thickness due to their electrostatic repulsion after removing the zeolite template. The oxidation treatment may be performed in a less irritating method using an oxidizing solution, the zeolite removal also may be performed by using a leaching solution, and the sonication needs no strong energy, whose entire process may be carried out with a mild chemical/physical treatment, this method is simple and economical and also, advantageous for mass production.

In the manufacturing method, the zeolite template has a two-dimensional pore structure. Since a two-dimensional pore structure less diffuses carbon precursors than a three-dimensional pore structure, it is important to use a zeolite template for synthesizing the two-dimensional microporous graphene. In other words, in order to secure uniform carbon deposition, it is necessary to use a two-dimensional zeolite template having micro pores with an appropriate size.

The zeolite template used in an embodiment has a two-dimensional structure pore structure, wherein the pores may have a size of a 10 membered-ring (MR). When a zeolite template having two-dimensional pores with a smaller size than the 10 membered-ring, sp² hybrid carbon skeletons may grow, which is not disadvantageous, but when a zeolite template having two-dimensional pores with a larger size than the 10 membered-ring, microporous graphene in which regular nanopores are formed may be effectively synthesized.

In the zeolite template, the two-dimensional pores may have a size of a 10 membered-ring or more, an 11 membered-ring or more, or a 12 membered-ring or more and a 30 membered-ring or less or a 20 membered-ring or less. When a zeolite template having a pore size satisfying the ranges is used, the microporous graphene oxide sheets with a two-dimensional structure may be successfully synthesized.

Specifically, the zeolite template may be at least one selected from *CTH, EWS, IWV, MWW, NES, OKO, *PCS, SEW, SFG, SFS, SSF, TER, USI, and UTL. In other words, when using a zeolite template with the exemplified structure, a microporous graphene oxide sheet can be effectively synthesized.

The carbon may be deposited through, for example, a chemical vapor deposition method. For example, the carbon may be deposited on the zeolite template by supplying a carbon precursor including acetylene, ethylene, propylene, ethanol, or a combination thereof. Herein, the carbon precursor may be supplied with helium gas. In other words, the carbon deposition may be performed under a helium gas atmosphere. In addition, the carbon deposition may be performed, for example, in a temperature range of about 573 K to about 1273 K for about 1 hour to about 48 hours.

On the other hand, when the carbon is deposited on the zeolite template, a nitrogen precursor and/or a sulfur precursor may be additionally supplied. Herein, the microporous graphene oxide sheets doped with the nitrogen and/or sulfur may be manufactured.

The nitrogen precursor may include, for example, ammonia, methyl amine, ethyl amine, propyl amine, butyl amine, acetonitrile, pyrrole, pyridine, or a combination thereof. The sulfur precursor may include hydrogen sulfide, thiophene, thiophenol, mercaptoethanol, thioacetic acid, methyl mercaptan, ethyl mercaptan, propyl mercaptan, butyl mercaptan, or a combination thereof. The nitrogen precursor and/or the sulfur precursor may be additionally supplied in each nitrogen and/or sulfur content of about 0.1 to about 20 wt % based on 100 wt % of the microporous graphene oxide sheets.

After depositing the carbon on the zeolite template, a heat treatment may be optionally performed. This may be a kind of carbonization process. The heat treatment may be performed, for example, in a temperature range of about 773K to about 1323K for about 30 minutes to about 10 hours or about 30 minutes to about 5 hours under the helium atmosphere.

Thereafter, oxidation of the prepared carbon-zeolite composite is performed. Through this step, it can be said that it is possible to later exfoliate into a graphene oxide sheet having a monoatomic thickness. The oxidation method is not particularly limited, but for example, a mild oxidation method using an oxidizing solution can be used. That is, the carbon-zeolite composite can be oxidized by adding the carbon-zeolite composite and the oxidizing agent to the solvent and mixing them. Herein, the solvent is referred to as the first solvent to distinguish it from the solvent in the sonication step to be described later. The carbon-zeolite composite may be dispersed in a first solvent, and an oxidizing agent may be added thereto. The oxidizing agent may include, for example, KMnO₄, H2O₂, HNO₃, NaNO₃, H₂SO₄, or a combination thereof, and may also be referred to as an aqueous solution including the same. The first solvent may be, for example, an aqueous solvent and may include water, an alcohol-based solvent, or a combination thereof.

Thereafter, it is possible to selectively remove only the zeolite template through the process of adding the oxidized carbon-zeolite composite to the leaching solution and stirring it. The leaching solution may include, for example, HCl, NaOH, KOH, HF, NaF, NH₄F, AlF₃, or a combination thereof. The leaching solution may be an aqueous solution including about 0.1 wt % to about 5 wt % of at least one of the exemplified compounds. The stirring may be carried out for, for example, about 10 to about 120 minutes. By selectively removing the zeolite template in this way, microporous graphene oxide having uniform nanopores can be obtained. The microporous graphene oxide obtained here has a thickness of greater than or equal to about 10 nm, and can be said to have a structure in which more than 10 monoatomic layers are stacked, and thus can be referred to as a microporous graphene oxide stack.

After separating the zeolite template by adding the leaching solution, the precipitate is recovered using a method such as centrifugation to obtain a microporous graphene oxide stack with the solvent removed. Thereafter, an additional process of optionally drying the obtained product may be performed.

The obtained microporous graphene oxide stack may be redispersed in a solvent and then subjected to sonication. Herein, the solvent may be referred to as a second solvent to distinguish it from the first solvent. The first solvent and the second solvent may be the same or different from each other. The second solvent may include, for example, N-methyl-2-pyrrolidone (NMP), N,N-dimethyl formamide (DMF), tetrahydrofuran (THF), toluene, acetone, water, methanol, ethanol, isopropyl alcohol, dimethylsulfoxide (DMSO), propylene glycolmethylether (PGME), propylene glycolmonomethyl ether acetate (PGMEA), ethyl-3-ethoxypropionate (EEP), butylcarbitol (BC), or a combination thereof. For example, the sonication may be performed for about 1 hour to about 20 hours under conditions of about 20 kHz to about 100 kHz. Through this process, microporous graphene oxide sheets having thickness of less than or equal to about 2 nm can be successfully exfoliated.

Microporous graphene oxide sheets containing a monoatomic layer or a few layers may be dispersed in the sonication-treated solution. Optionally, centrifugation is performed and the supernatant is recovered to obtain a dispersion in which microporous graphene oxide sheets having a thickness of less than or equal to about 2 nm are dispersed in a solvent.

Specifically, a method of manufacturing a microporous graphene oxide sheet according to an embodiment includes (i) depositing carbon on a zeolite template having a two-dimensional pore structure to prepare a carbon-zeolite composite, (ii) dispersing the carbon-zeolite composite in a first solvent and then adding an oxidizing agent thereto to oxidize it, (iii) adding a leaching solution thereto to remove zeolite from the oxidized carbon-zeolite composite, (iv) obtaining microporous graphene oxide as a precipitate through centrifugation, (v) redispersing the obtained product in a second solvent and then sonicating it, and (vi) centrifuging to recover the supernatant.

The finally obtained microporous graphene oxide sheet is a porous sheet having a uniform pore size, regular spacing between pores, and high pore density, and is a monoatomic layer sheet with a thickness of less than or equal to about 2 nm. Physical properties such as pore characteristics and thickness of the microporous graphene oxide sheet are the same as described above.

On the other hand, after obtaining the microporous graphene oxide sheets, a step of drying them may be included, and subsequently, a treatment with oxygen (O₂) or hydrogen (H₂) gas may additionally proceed. Herein, the microporous graphene oxide, reduced graphene oxide, etc. in which edge sites are substituted with oxygen or hydrogen may be manufactured, wherein an effective pore size and surface polarity may be appropriately adjusted.

### Dispersion

In an embodiment, a dispersion includes a solvent, and microporous graphene oxide sheets dispersed in the solvent and having a thickness of less than or equal to about 2 nm. Herein, the ‘microporous’ means pores with less than or equal to about 2 nm, and the ‘thickness of less than or equal to about 2 nm’ means a monoatomic layer thickness. In other words, the dispersion may be that graphene oxide sheets with a microporous structure having nanopores of less than or equal to about 2 nm, which are exfoliated into a monoatomic layer thickness, are dispersed in a solvent. In addition, the sheets are partially or fully oxidized graphene, which has an atomic ratio of oxygen to carbon of about 0.1 to about 1.0, about 0.2 to about 0.9, or about 0.3 to about 0.8.

Various methods of synthesizing a graphene-based carbon material having a porous structure and a monoatomic layer thickness have been conventionally researched, which are not to obtain it as a dispersion of being dispersed in a solvent and thus not economical and impossible to apply for mass production. The microporous graphene oxide sheets according to an embodiment, which have a uniform pore distribution and are exfoliated into a monoatomic layer thickness, may be synthesized and stored in a dispersed state in a solution and thus economical and simple and thus may be applied into various fields and also, manufactured into a high-performance carbon material or membrane.

The solvent is not particularly limited, but may be, for example, N-methyl-2-pyrrolidone (NMP), N,N-dimethylformamide (DMF), tetrahydrofuran (THF), toluene, acetone, water, methanol, ethanol, isopropyl alcohol, dimethyl sulfoxide (DMSO), propylene glycol methyl ether (PGME), propylene glycol monomethyl ether acetate (PGMEA), ethyl-3-ethoxypropionate (EEP), butyl carbitol (BC), or a combination thereof.

In the dispersion, the microporous graphene oxide sheets may have, for example, an average pore size of about 0.1 nm to about 2 nm, a spacing between pores of about 0.3 nm to about 10 nm, and a standard deviation for the spacing between the pores of less than or equal to about 5 nm. In other words, in the dispersion, the microporous graphene oxide sheets, in which very small pores are very regularly distributed, may be exfoliated into a monoatomic layer thickness. Details of a pore distribution, characteristics, a thickness, etc. of the microporous graphene oxide sheets are the same as described above and will not be repeated.

### Membrane

An embodiment provides a membrane including a stack of the microporous graphene oxide sheets. The stack may be a thin film or coating layer in which microporous graphene oxide sheets having a monoatomic layer thickness are well-interlocked layer-by-layer. These stacks can be high-quality lamellar structures without internal defects or pinholes.

For example, the membrane includes a substrate and a carbon coating layer on the substrate, and the carbon coating layer may be a stack of the aforementioned microporous graphene oxide sheets. This membrane can be called a TFC (Thin Film Composite) membrane in the shape of a two-dimensional flat sheet. The membrane has no defects and includes a carbon coating layer in which uniform nanopores are regularly formed, and thus it has excellent performance in selectively permeating various molecules and ions, and can therefore be applied as a separation membrane or filter in various fields.

A thickness of the carbon coating layer may be about 10 nm to about 50 μm, for example about 10 nm to about 40 μm, about 10 nm to about 30 μm, about 10 nm to about 20 μm, about 10 nm to about 10 μm, about 10 nm to about 5 μm, about 15 nm to about 1 μm, or about 100 nm to about 900 nm, etc., and it is possible to adjust the thickness appropriately depending on the use.

The type of the substrate is not particularly limited and can be appropriately selected and used depending on the purpose. For example, when used as a separator, a porous substrate can be used. For example, the substrate may include glass fiber, cellulose fiber, nylon, polycarbonate, polyethersulfone, polyester, polyethylene, polypropylene, polytetrafluoroethylene, polyethyleneterephthalate, polyacrylate, polyimide, polystyrene, polyethylenenaphthalate, aluminum oxide, silicon oxide, or a combination thereof. As an example, the substrate may include nylon, polycarbonate track etched (PCTE), anodic aluminum oxide (AAO), or a combination thereof.

### Method of Manufacturing Membrane

An embodiment provides a method for manufacturing the membrane. This method of manufacturing the membrane includes stacking microporous graphene oxide sheets after obtaining the microporous graphene oxide sheets with a thickness of less than or equal to about 2 nm in the above method.

The method of stacking the microporous graphene oxide sheets on a substrate may be vacuum filtration, spin coating, doctor-blade coating, roll-to-roll coating, and the like but is not limited thereto. For example, a dispersion in which the microporous graphene oxide sheets are dispersed is vacuum-filtered to manufacture a membrane in which the microporous graphene oxide sheets are stacked on a substrate. This method of manufacturing the membrane is a solution process, which is simple and economical and also, advantageous for commercialization.

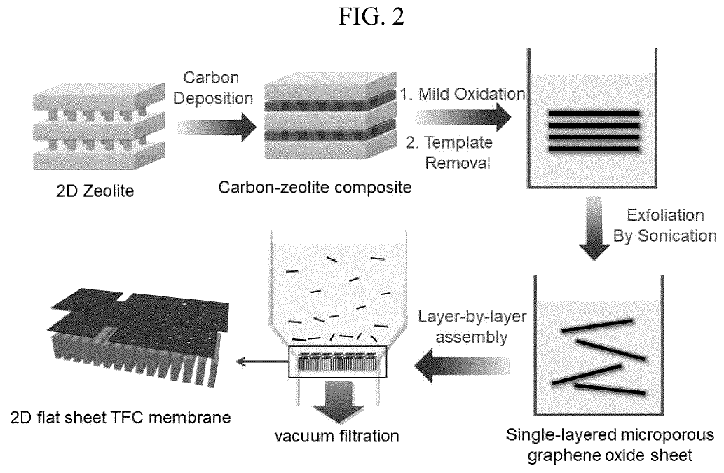

FIG. 2 is a diagram schematically illustrating the method of the microporous graphene oxide sheets and subsequently, the method of manufacturing the membrane according to an embodiment for better understanding.

As described above, even though a two-dimensional microporous carbon material is successfully manufactured, if not exfoliated into a monoatomic layer thickness, it may not be layer by layer interlocked and stacked into a membrane and not even into a high-quality membrane due to defects or pinholes in the structure. On the contrary, an embodiment is strategically designed by using a zeolite template having a two-dimensional pore structure to obtain two-dimensional microporous graphene with uniform nanopores but easily separate the microporous graphene into a monoatomic layer thickness so that the separated microporous graphene may be layer by layer interlocked and stacked successfully into a membrane with no defects.

Specifically, after depositing and oxidizing carbon on the zeolite template with a two-dimensional pore structure, the template may be removed to obtain partially oxidized two-dimensional microporous graphene. Since in this oxidized graphene, electrostatic repulsion of oxygen functional groups works, the partially oxidized two-dimensional microporous graphene may be easily exfoliated into microporous graphene oxide sheets with a monoatomic layer thickness. These exfoliated sheets are stacked on a substrate in conventional various methods such as vacuum filtration and the like to manufacture a high-performance membrane with no defects according to an embodiment.

Hereinafter, examples of the present invention, comparative examples, and evaluation examples thereof are described. The following examples are only examples of the present invention, and the present invention is not limited to the following examples.

### REFERENCE EXAMPLE 1

An IWV zeolite template with a two-dimensional pore structure composed of 12-membered rings (12MRs) is injected into a quartz reactor and then, heated to 773 K, while supplying helium gas thereinto. Subsequently, a mixed gas of ethylene and helium (ethylene: 20 volume %) is supplied at 200 mL/min for 2 hours to deposit carbon on the zeolite template. Then, while helium gas is flowing at 200 mL/min, the reactor is heated to 1273 K, and after the temperature is stabilized, the heat treatment proceeds for 2 hours. Subsequently, the reactor is cooled to room temperature under a helium atmosphere to obtain a carbon-zeolite composite. This composite is stirred in an aqueous solution of 1.1 wt % HCl and 0.8 wt % HF for 1 hour to remove the zeolite template and then, dried at 373 K for 24 hours. Through this, synthesized is microporous graphene with a two-dimensional structure in which nanopores with a uniform size are formed.

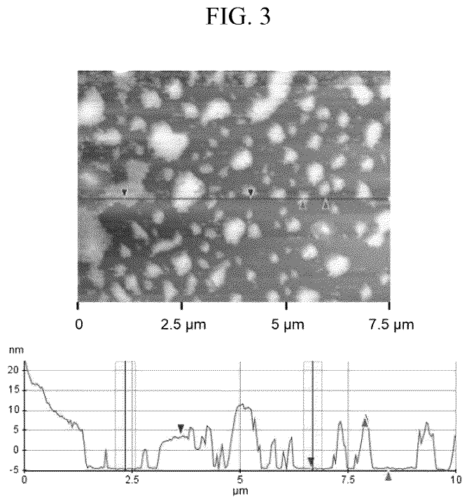

The microporous graphene according to Reference Example 1 is taken an image of with an atomic force microscope (AFM), which is used to analyze a thickness thereof, and the result is shown in FIG. 3. Referring to the result of FIG. 3, the prepared graphene turns out to have an average thickness of about 15 nm or less, which is understood to be a structure that about 40 monoatomic layers are stacked. When this microporous graphene is dispersed in an NMP solvent and sonicated (bath sonication), the stacked sheets have so strong π-π attraction between themselves and are not exfoliated at all. Accordingly, as a result of a treatment with stronger energy (e.g. horn-type ultrasonication) than the π-π attraction, there is a problem that the exfoliated graphene sheets are broken.

### EXAMPLE 1

### 1. Manufacture of Microporous Graphene Oxide Sheets

1 g of the carbon-zeolite composite according to Reference Example 1 is added to 100 mL of distilled water and then, stirred for 30 minutes. Subsequently, 1 g of KMnO₄ as an oxidizing agent is added thereto and then, mixed at 60° C. for 2 hours to conduct an oxidation treatment. Then, 50 mL of a 2.0 M HCl aqueous solution as a leaching solution is added thereto and then, stirred at 60° C. for 2 hours, and 50 mL of a 2.0 M HF aqueous solution is further added thereto and then, stirred at room temperature (25° C.) for 2 hours to remove a zeolite template. Subsequently, precipitates are recovered therefrom through centrifugation at 9000 rpm to obtain partially oxidized microporous graphene.

The oxidized microporous graphene is dispersed in 100 mL of an NMP solvent and then, sonicated at 40 kHz for 6 hours. Subsequently, a supernatant is recovered therefrom through centrifugation at 9000 rpm.

### 2. Manufacture of Membrane

The obtained supernatant is vacuum-filtered to from a carbon coating layer in which the monoatomic thick microporous graphene oxide sheets are interlocked layer by layer on a porous nylon substrate into a TFC (Thin Film Composite) membrane.

### EVALUATION EXAMPLE 1

### Analysis of Pore Distribution and Thickness of Graphene Oxide Sheet

After recovering the supernatant in Example 1, microporous graphene oxide sheets are obtained by removing the solvent and drying at 373 K for 24 hours.

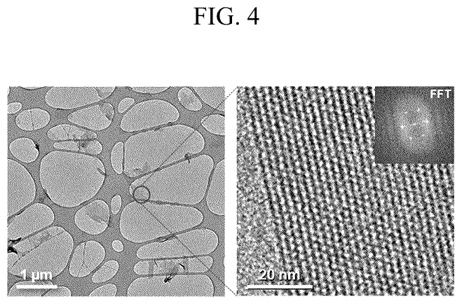

FIG. 4 is a transmission electron microscope (TEM) image showing that pores with a two-dimensional structure are very regularly formed in the obtained microporous graphene oxide sheets. As an analysis result through FIG. 4, the synthesized graphene oxide sheets turn out to have pore density of about 70 pore/100 nm².

In the TEM image of FIG. 4, any 50 pores are selected and measured with respect to each pore size, whose arithmetic average is 0.68 nm, and a standard deviation of the average pore size is 0.063 nm. In addition, in the TEM image of FIG. 4, when 50 pores are randomly measured with respect to a distance from a center of one pore to another center of a neighboring pore, an arithmetic average thereof is calculated to be 1.23 nm, and a standard deviation thereof is calculated to be 0.062 nm.

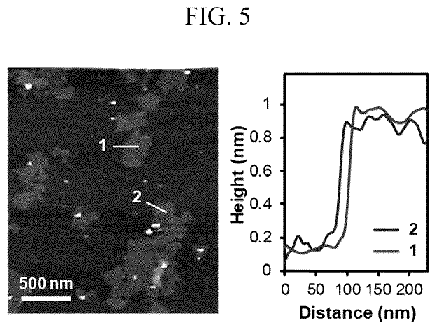

A left image of FIG. 5 is an atomic force microscopic (AFM) image of the obtained dried microporous graphene oxide sheets. Herein, a thickness of the graphene oxide sheets at positions No. 1 and 2 is analyzed, and the result is shown at right of FIG. 5. Referring to FIG. 5, the obtained graphene oxide sheets are analyzed to have a thickness of about 1 nm or less. Accordingly, the microporous graphene oxide sheets exfoliated into a monoatomic thickness are confirmed to be successfully manufactured by the method of Example 1.

### EVALUATION EXAMPLE 2

### Membrane Analysis

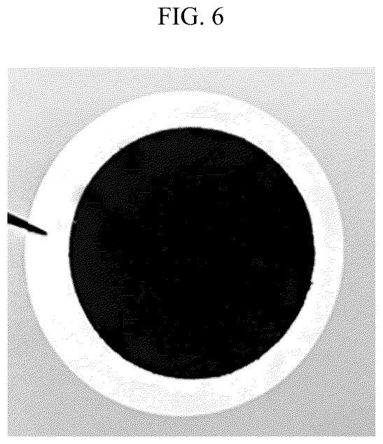

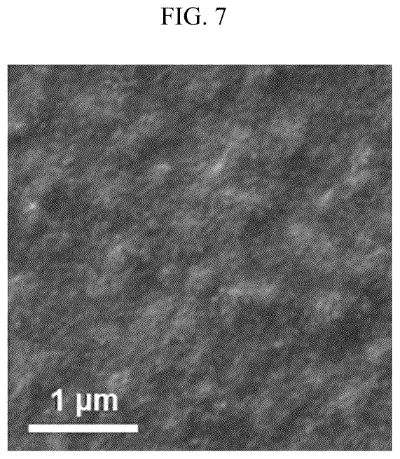

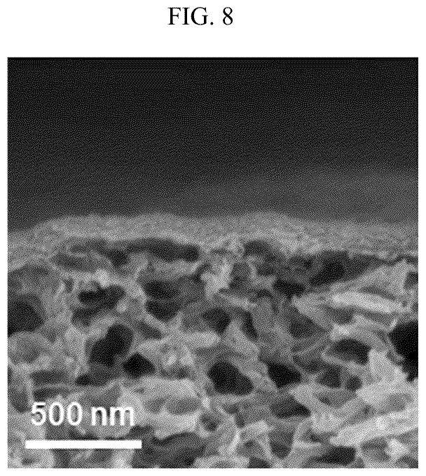

FIG. 6 is an SEM image of the membrane according to Example 1. FIG. 7 is an SEM image of the surface of the carbon-coated portion. FIG. 8 is an SEM image of a cross-section of the membrane. Referring to FIGS. 6 to 8, carbon coating layer with a lamellar structure is formed on the porous nylon substrate surface, which confirms that a TFC membrane of a two-dimensional flat sheet is successfully manufactured.

In order to evaluate organic solvent nanofiltration characteristics of the manufactured membrane, performance of the membrane is analyzed by using a solution in which organic dye molecules with various molecular weights (260 to 1018 g mol⁻¹) and charges (+/−) are dispersed in a methanol solvent. In all the nanofilter tests, a transmembrane pressure is fixed at 1 bar, a filtration rate (rejection rate) of methanol permeability and a solute (organic dye molecules) is measured 30 minutes after starting nanofiltration.

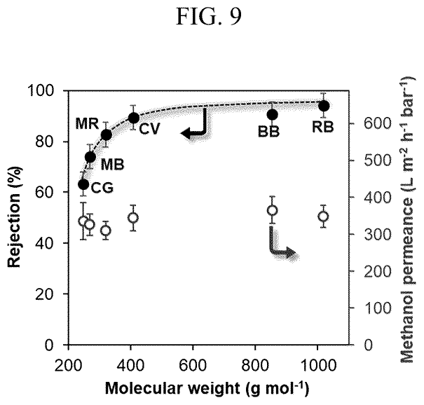

FIG. 9 shows the organic solvent nanofilter result of the membrane of Example 1 (CG: Chrysoidine G, MR: Methyl Red, MB: Methylene Blue, CV: Crystal Violet, BB: Brilliant Blue G, RB: Rose Bengal). Referring to FIG. 9, the membrane according to an embodiment shows effective filter performance of 90% or more for all dye molecules having a molecular weight of 408 g mol⁻¹ or more. In particular, even though the organic dye molecules have various charges, a filter curve (rejection curve) appears as a function of molecular weight, which means that the carbon sheets forming the active layer in the separation mechanism of the membrane dominantly play a molecular sieving role.

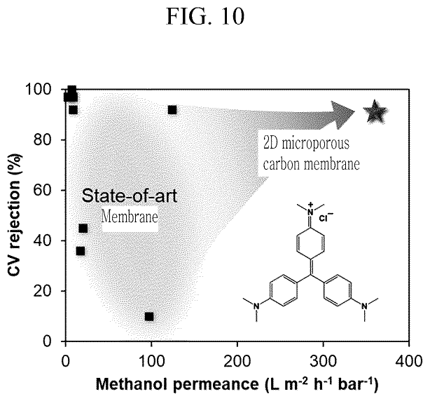

FIG. 10 is a graph showing a filtration rate (rejection rate) of CV (Crystal Violet), organic dye molecules, and methanol permeability by comparing organic solvent nanofilter performance of the membrane of Example 1 with organic solvent nanofilter performance of a conventional state-of-art membrane. Referring to FIG. 10, the membrane of an embodiment shows excellent solvent permeability and solute filtration characteristics, compared with other conventional membranes. This is due to the unique pore structure of the membrane, wherein high micropore density results in high permeability of a solvent, and uniform micropore sizes results in a high solute filtration rate (rejection rate). In particular, since the present membrane has a much thicker active layer thickness (200 nm) than an active layer thickness (<80 nm) of the conventional commercially available membranes but exhibits superbly excellent membrane performance, the 2D microporous graphene oxide sheets according to an embodiment may be said to be a very excellent membrane material.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A microporous graphene oxide sheet, comprising
an average size of pores ranging from about 0.1 nm to about 2 nm, wherein a spacing between pores is about 0.3 nm to about 10 nm, a standard deviation for the spacing between pores is less than or equal to about 5 nm, and
the microporous graphene oxide sheet has a thickness of less than or equal to about 2 nm.

2. The microporous graphene oxide sheet of claim 1, wherein
an atomic ratio of oxygen to carbon is about 0.1 to about 1.0.

3. The microporous graphene oxide sheet of claim 1, wherein
about 10 wt % to about 60 wt % of oxygen is included based on 100 wt % of the microporous graphene oxide sheet.

4. The microporous graphene oxide sheet of claim 1, wherein
a standard deviation for the average size of the pores is less than or equal to about 1 nm.

5. The microporous graphene oxide sheet of claim 1, wherein
a pore density is about 10 pore/100 nm² to 100 pore/100 nm².

6. A method of manufacturing a microporous graphene oxide sheet, comprising
depositing carbon on a zeolite template having a two-dimensional pore structure to prepare a carbon-zeolite composite,
oxidizing the carbon-zeolite composite,
removing the zeolite from the oxidized carbon-zeolite composite to obtain microporous graphene oxide, and
treating the obtained product with sonication in a solvent,
to obtain a microporous graphene oxide sheet having a thickness of less than or equal to about 2 nm.

7. The method of claim 6, wherein
the obtained microporous graphene oxide sheet has average size of pores ranging from about 0.1 nm to about 2 nm, a spacing between pores is about 0.3 nm to about 10 nm, and a standard deviation for the spacing between pores is less than or equal to about 5 nm.

8. The method of claim 6, wherein
the zeolite template has a two-dimensional pore structure having a size of 10 membered-ring or more.

9. The method of claim 6, wherein
the zeolite template is at least one selected from *CTH, EWS, IWV, MWW, NES, OKO, *PCS, SEW, SFG, SFS, SSF, TER, USI, and UTL.

10. The method of claim 6, wherein
the carbon is deposited through chemical vapor deposition using a carbon precursor including acetylene, ethylene, propylene, ethanol, or a combination thereof.

11. The method of claim 6, wherein
the oxidizing of the carbon-zeolite composite includes mixing the carbon-zeolite composite and an oxidizing agent in a solvent, and
the oxidizing agent includes KMnO₄, H₂O₂, HNO₃, NaNO₃, H₂SO₄, or a combination thereof.

12. The method of claim 6, wherein
the removing of the zeolite from the oxidized carbon-zeolite composite includes mixing the oxidized carbon-zeolite composite with a leaching solution, and
the leaching solution includes HCl, NaOH, KOH, HF, NaF, NH₄F, AlF₃, or a combination thereof.

13. The method of claim 6, wherein
the method further includes,
after removing the zeolite from the oxidized carbon-zeolite composite,
obtaining microporous graphene oxide as a precipitate through centrifugation, and
dispersing the obtained product in a solvent.

14. The method of claim 6, wherein
the sonication is performed for about 1 hour to about 20 hours under conditions of about 20 kHz to about 100 kHz.

15. The method of claim 6, wherein
after sonication, centrifugation is performed and the supernatant is recovered to obtain a dispersion in which microporous graphene oxide sheets having a thickness of less than or equal to about 2 nm are dispersed in a solvent.

16. A dispersion comprising
a solvent, and
microporous graphene oxide sheets dispersed in the solvent and having a thickness of less than or equal to about 2 nm.

17. The dispersion of claim 16, wherein
the microporous graphene oxide sheet has an average size of pores ranging from about 0.1 nm to about 2 nm, a spacing between pores is about 0.3 nm to about 10 nm, and a standard deviation for the spacing between pores is less than or equal to about 5 nm.

18. The dispersion of claim 16, wherein
the microporous graphene oxide sheet has a pore density of about 10 pore/100 nm² to about 100 pore/100 nm².

19. The dispersion of claim 16, wherein
the microporous graphene oxide sheet has an atomic ratio of oxygen to carbon of about 0.1 to about 1.0.

20. The dispersion of claim 16, wherein
the solvent includes N-methyl-2-pyrrolidone (NMP), N,N-dimethyl formamide (DMF), tetrahydrofuran (THF), toluene, acetone, water, methanol, ethanol, isopropyl alcohol, dimethylsulfoxide (DMSO), propylene glycolmethylether (PGME), propylene glycolmonomethyl ether acetate (PGMEA), ethyl-3-ethoxypropionate (EEP), butylcarbitol (BC), or a combination thereof.

21. A membrane comprising a stack of microporous graphene oxide sheets according to claim 1.

22. The membrane of claim 21, wherein
the membrane includes a substrate and a carbon coating layer on the substrate, wherein the carbon coating layer includes the stack of microporous graphene oxide sheets.

23. The membrane of claim 22, wherein
the carbon coating layer has a thickness of about 10 nm to about 50 μm.

24. The membrane of claim 22, wherein
the substrate includes glass fiber, cellulose fiber, nylon, polycarbonate, polyethersulfone, polyester, polyethylene, polypropylene, polytetrafluoroethylene, polyethylene terephthalate, polyacrylate, polyimide, polystyrene, polyethylene naphthalate, aluminum oxide, silicon oxide, or a combination thereof.

25. A method of manufacturing a membrane, comprising
manufacturing a microporous graphene oxide sheet according to the method of claim 6, and
stacking microporous graphene oxide sheets on a substrate.
